(19) United States
(12) Patent Application Publication
(10) Pub. No.: US 2018/0111156 A1
(43) Pub. Date: Apr. 26, 2018

(54) METHOD OF FABRICATING SAMPLE STAGE FOR MICROSPECTROMETRIC ANALYSIS

(71) Applicant: Toray Research Center, Inc., Tokyo (JP)

(72) Inventors: Hirofumi Moriwaki, Otsu (JP); Miyuki Ogawa, Otsu (JP)

(21) Appl. No.: 15/562,985

(22) PCT Filed: Mar. 7, 2016
(86) PCT No.: PCT/JP2016/056993

§ 371 Date: Sep. 29, 2017

(30) Foreign Application Priority Data
Apr. 2, 2015 (JP) 2015-075594
Oct. 28, 2015 (JP) 2015-211480
Dec. 7, 2015 (JP) 2015-238183

(51) Int. Cl. B05D 1/18; G01N 21/01; G01N 21/25; G02B 21/26

(52) U.S. Cl. CPC B05D 1/18; G02B 21/26; G01N 21/255; G01N 21/01

(57) ABSTRACT

A method of fabricating a specimen stage for microspectrometric analysis uses an optical material with a water repellent or oil repellent surface produced by immersing an optical material in a solution of a water repellent or oil repellent perfluoroalkyl-polyether-group-containing silane compound as represented by structural formula (I) dissolved in a solvent, heating the optical material after immersion, and washing the optical material to modify a surface thereof:

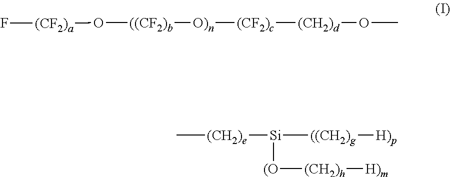

wherein a is an integer of 1 to 30; b is an integer of 1 to 10; c is an integer of 1 to 20, d is an integer of 1 to 10; e is an integer of 1 to 20; his an integer of 0 to 10; g is an integer of 0 to 20; n is an integer of 1 to 320; and the sum of m and p is 3.

### TECHNICAL FIELD

This disclosure relates to a method of fabricating a sample stage for microspectrometric analysis.

### BACKGROUND

Microspectrometric techniques such as those by micro-FTIR (Fourier transform infrared microspectrophotometry) are effective for qualitative analysis of a trace amount of a minute organic specimen. When applying micro-FTIR to qualitative analysis, for example, a good FTIR spectrum cannot be obtained if the specimen to be examined does not have an appropriate thickness and, accordingly, the specimen preparation procedure is an important factor in obtaining a good FTIR spectrum. In the conventionally used procedure to perform micro-FTIR for a specimen in a dilute solution, for example, a pinhole to act as a condensation nucleus of a solution of a specimen in a solvent is produced in a thin fluorine resin film located on the infrared ray reflection member of a specimen stage, and the pinhole is examined by micro-FTIR to obtain information on components of the solute in a trace amount of the dilute solution, as disclosed in Japanese Unexamined Patent Publication (Kokai) No. HEI 5-99813 and Japanese Unexamined Patent Publication (Kokai) No. HEI 5-240785.

With that method, however, the condensation nucleus has a large thickness and the resulting FTIR spectra are in a saturated state as a whole, leading to serious difficulty in spectrum analysis for qualitative examination of the components and easy destruction of the thin fluorine resin film attached on the member.

### SUMMARY

We thus provide:

(1) A method of fabricating a specimen stage for microspectrometric analysis using an optical material with a water repellent or oil repellent surface produced by immersing an optical material in a solution of a water repellent or oil repellent perfluoroalkyl-polyether-group-containing silane compound as represented by structural formula (I) dissolved in a solvent, heating the optical material after the immersion step, and washing the optical material to modify the surface thereof:

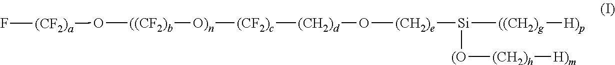

wherein a is an integer of 1 to 30; b is an integer of 1 to 10; c is an integer of 1 to 20, d is an integer of 1 to 10; e is an integer of 1 to 20; his an integer of 0 to 10; g is an integer of 0 to 20; n is an integer of 1 to 320; and the sum of m and p is 3.
(2) A method of fabricating a specimen stage for microspectrometric analysis as set forth in paragraph (1), wherein the optical material contains one or more substances selected from the group consisting of silicon, germanium, sapphire, calcium fluoride, barium fluoride, zinc selenide, and diamond.
(3) A method of fabricating a specimen stage for microspectrometric analysis as set forth in either paragraph (1) or (2), wherein the solvent contains one or more substances selected from the group consisting of alcohols, ketones, ethers, aldehydes, amines, fatty acids, esters, and nitriles, and the solvent is modified with fluorine.
(4) A method of fabricating a specimen stage for microspectrometric analysis as set forth in any one of paragraphs (1) to (3), wherein the specimen is crushed using a needle having an end diameter of 2 to 10 μm.
(5) A method of fabricating a specimen stage for microspectrometric analysis as set forth in any one of paragraphs (1) to (4), wherein the modified surface of the optical material has a region with an area of 0.001 to 10 mm² enclosed by straight or curved lines with a width of 1 to 1,000 μm to retain a solution therein.
(6) A method of fabricating a specimen stage for microspectrometric analysis as set forth in any one of paragraphs (1) to (5), wherein the lines around the region have a raised part with a height of 0.001 to 1 μm.
(7) A method of fabricating a specimen stage for microspectrometric analysis as set forth in any one of paragraphs (1) to (6), wherein the lines around the region have a depressed part with a depth of 0.001 to 1 μm.
(8) A method of fabricating a specimen stage for microspectrometric analysis as set forth in any one of paragraphs (1) to (7), wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

Our method enables, for example, simple and more accurate condensation operation of microspectrometric analysis using a plate produced by easily forming an intended water repellent or oil repellent perfluoroalkyl-ether-group containing thin film on the surface of an optical material.

### BRIEF DESCRIPTION OF THE DRAWINGS

FIG. 1 is a schematic diagram illustrating a method of condensing a specimen for microspectrometric analysis.

FIG. 2 is a schematic diagram illustrating another method of condensing a specimen for microspectrometric analysis.

FIG. 3 is a schematic diagram illustrating still another method of condensing a specimen for microspectrometric analysis.

FIG. 4 shows a FTIR spectrum of a specimen on silicon after water repellent treatment.

FIG. 5 shows a FTIR spectrum of a specimen on a thin fluorine resin film attached to the infrared ray reflection member.

FIG. 6 shows a FTIR spectrum of a specimen crushed by a needle on silicon after water repellent treatment.

FIG. 7 shows a FTIR spectrum of a specimen on silicon after thickness control treatment by retaining a solution and water repellent treatment.

FIG. 8 shows a FTIR spectrum of a specimen on silicon after thickness control treatment using a groove and water repellent treatment.

FIG. 9 shows a FTIR spectrum of a specimen observed by an optimum method.

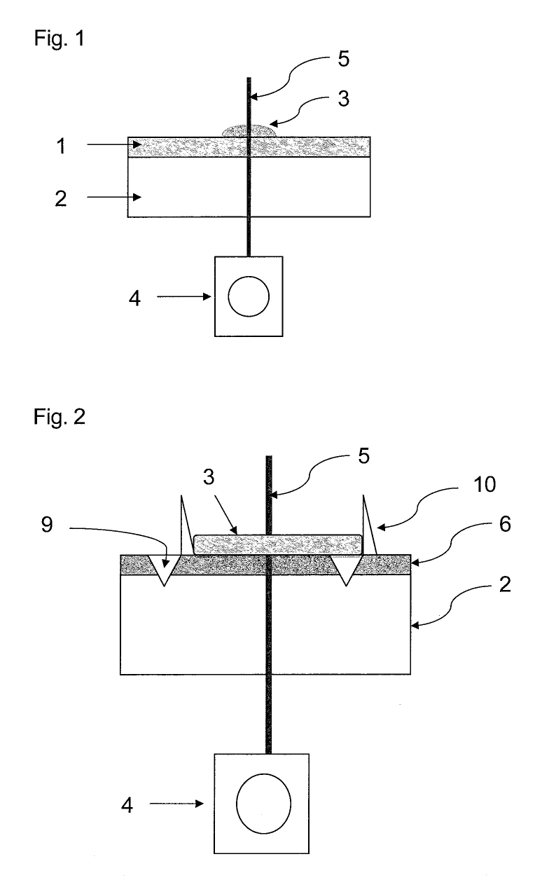

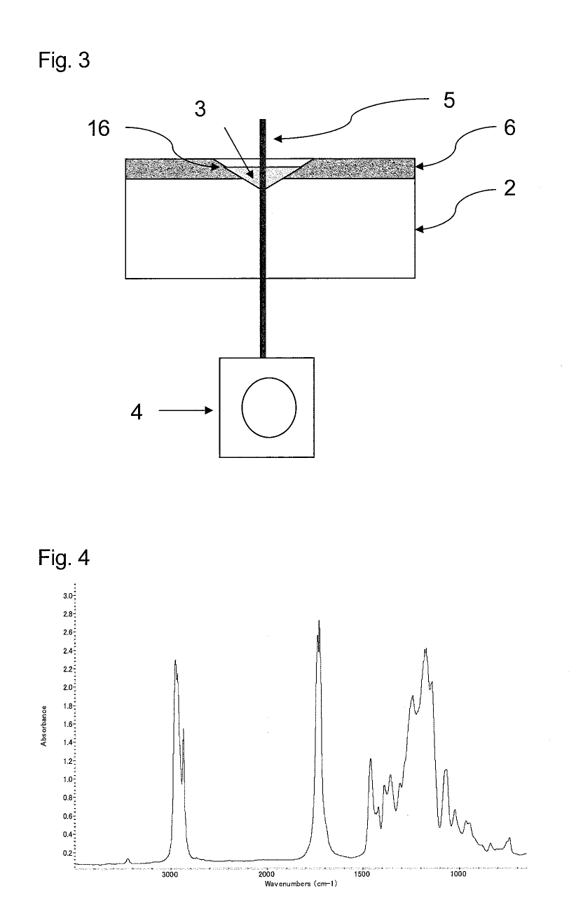

### EXPLANATION OF NUMERALS

1: modified region
2: optical material
3: specimen
4: detector
5: infrared ray
6: modified surface region
9: depressed region
10: raised region
16: groove

### DETAILED DESCRIPTION

Our method will be described below.

A preferred example of the water repellent or oil repellent compound is a perfluoroalkyl-polyether-group-containing silane compound as represented by structural formula (I).

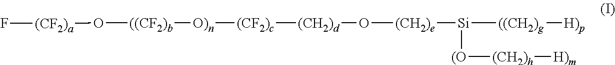

wherein a is an integer of 1 to 30; b is an integer of 1 to 10; c is an integer of 1 to 20, d is an integer of 1 to 10; e is an integer of 1 to 20; his an integer of 0 to 10; g is an integer of 0 to 20; n is an integer of 1 to 320; and the sum of m and p is 3.

Preferred examples of the solvent include alcohols, ketones, ethers, aldehydes, amines, fatty acids, esters, and nitriles that are modified with fluorine. In particular, fluorine modified ethers and fluorine modified alcohols are particularly preferable, and it is the most preferable for these ethers and alcohols to contain 2 to 20 carbon atoms.

The solution prepared by dissolving such a water repellent or oil repellent compound in a solvent preferably has a concentration of 0.001 to 10 mass %, more preferably 0.01 to 1 mass %.

A coating technique may be adopted to carry out such modification and, in that case, useful techniques include dip coating and spin coating. An optical material is preferably low in infrared ray absorbance, and useful examples include silicon, germanium, sapphire, calcium fluoride, barium fluoride, zinc selenide, and diamond. Of these, silicon is particularly preferable. The effect of improving both easiness and accuracy is realized if the surface of the optical material to be treated is mirror-finished by polishing in advance.

The optical material is immersed in the aforementioned liquid and after the immersion step, the optical material is dried by heating.

“Heating of an optical material” means holding it at 80° C. to 150° C. for 30 minutes to 3 hours. It is more preferable to hold it at 90° C. to 110° C. for 30 minutes to 1 hour.

The technique to control the specimen thickness is to provide a groove or depression to ensure easy and accurate condensation operation. It is preferable to mirror-finish the surface by polishing in advance, and the surface on which the solution specimen is to be condensed preferably has a region with an area of 0.001 to 10 mm², more preferably 0.001 to 0.1 mm², enclosed by straight or curved lines with a width of 1 to 1,000 μm to retain the solution therein.

Furthermore, it is the most preferable that the lines have a raised part with a height of 0.001 to 1 μm or have a depressed part with a depth of 0.001 to 1 μm. Such a region can be defined using a material that is more rigid than the optical material.

Preferably, the modified surface of the optical material has a groove with a width of 0.01 to 1 mm and a depth of 0.001 to 0.1 mm or has a depression with a diameter of 0.01 to 1 mm and a depth of 0.001 to 0.1 mm.

### EXAMPLES

Our method will now be illustrated with reference to Examples, but it should be understood that this disclosure is not construed as being limited thereto.

First, the perfluoroalkyl-polyether-group-containing silane compound shown below was adopted as the water repellent or oil repellent compound.

F—(CF₂)₃—O—((CF₂)₃—O)₃₂—(CF₂)₂—CH₂—O—(CH₂)₃—Si—(O—CH₃)₃

Specifically, its 0.1 mass % solution in ethyl nonafluorobutyl ether, namely, DS-5210TH (manufactured by Harves), was used. The average degree of polymerization of the chemical formula (n=32 for the above structural formula (I)) is a calculation from ¹⁹F NMR.

A silicon plate with a surface mirror-finished by polishing in advance was immersed in the aforementioned solution.

After the immersion step, the silicon was dried by heating at 100° C. for 1 hour. After the drying step, residual DS-5210TH was removed by washing with DS-TH (manufactured by Harves).

As a result of the above treatment, a thin film of about 10 Å (0.001 μm) was formed on the silicon surface. This was confirmed from an ion image of a 5 mm×5 mm square region taken by time-of-flight secondary ion mass spectrometry (TOF-SIMS) with an analyzing depth of 1 to several nanometers that molecular structures with water repellency such as SiO₃H ion, C₃F₅O₂ ion, and C₃F₇O ion, were located uniformly.

The curve in FIG. 4 shows a FTIR spectrum observed by transmission type infrared spectroscopy of a specimen prepared by condensing 100 ng (nanograms) of dibutyl adipate on a water repellent silicon surface, and the curve in FIG. 5 shows a FTIR spectrum observed by reflection type infrared spectroscopy of a specimen prepared by condensing 100 ng (nanograms) of dibutyl adipate on a thin fluorine resin film attached to an infrared ray reflection member.

The spectrum obtained, which is shown in FIG. 4, is better than that in FIG. 5 over the entire 700 to 4,000 cm⁻¹ region.

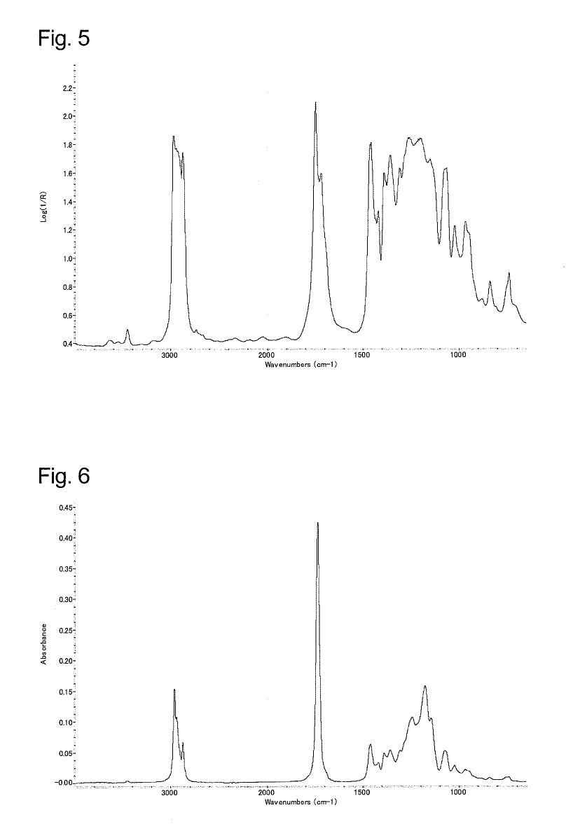

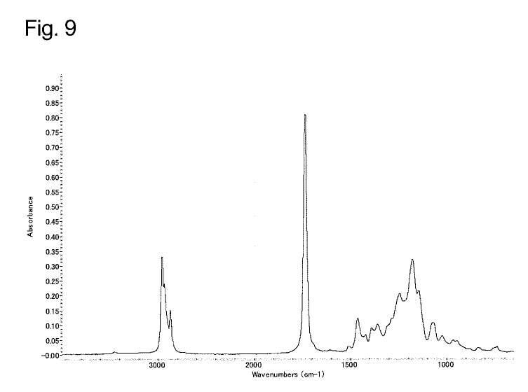

When a specimen condensed on a water repellent silicon surface and crushed by a needle with an end diameter of 2 to 10 μm was examined by transmission type infrared spectroscopy, the FTIR spectrum obtained, which is given in FIG. 6, was comparable to the FTIR spectrum obtained from observation by an optimum method shown in FIG. 9.

In another test, a rectangular region (0.028 mm²) with a long side of 280 μm and a short side of 100 μm defined by lines with a width of 10 μm was produced by a diamond pen (D-Point Pen, manufactured by Ogura Jewel Industry Co., Ltd.) on a modified surface. Examination of the lines performed by a surface roughness tester (Dektak, manufactured by Bruker) showed that the roughness was 200 nm in the depressed regions and 600 nm in the raised regions.

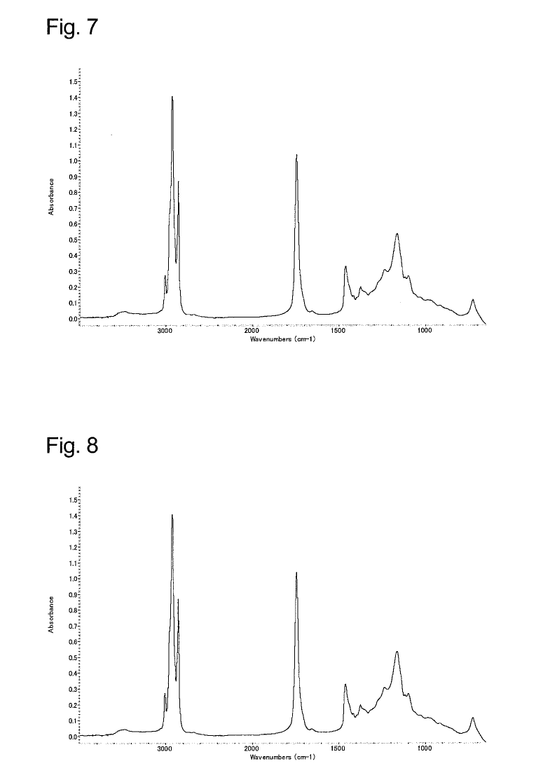

A solution of 1,000 ng of soybean oil in 5 μL of chloroform was dropped on the aforementioned silicon surface and, after volatilizing chloroform, condensed on the aforementioned rectangular region, and the soybean oil was analyzed by transmission type infrared spectroscopy. The FTIR spectrum obtained, which is shown in FIG. 7, is comparable to that in FIG. 9 over the entire 700 to 4,000 cm⁻¹ region.

A silicon plate having a surface mirror-finished by polishing in advance and having a groove with a width of 0.1 mm and a depth of 0.005 mm on the surface on which the solution specimen is to be condensed was immersed in the aforementioned solution and, after the immersion step, the silicon was dried by heating at 100° C. for 1 hour. After the drying step, residual DS-5210TH was removed by washing with DS-TH (manufactured by Harves).

The curve in FIG. 8 shows a FTIR spectrum observed by transmission type infrared spectroscopy of a specimen prepared by condensing 1,000 ng of soybean oil on a water repellent silicon surface, suggesting that the spectrum obtained is comparable to that in FIG. 9 over the entire 700 to 4,000 cm⁻¹ region.

1.-8. (canceled)

9. A method of fabricating a specimen stage for microspectrometric analysis using an optical material with a water repellent or oil repellent surface produced by immersing an optical material in a solution of a water repellent or oil repellent perfluoroalkyl-polyether-group-containing silane compound as represented by structural formula (I) dissolved in a solvent, heating the optical material after immersion, and washing the optical material to modify a surface thereof: 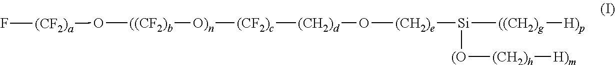
wherein a is an integer of 1 to 30; b is an integer of 1 to 10; c is an integer of 1 to 20, d is an integer of 1 to 10; e is an integer of 1 to 20; his an integer of 0 to 10; g is an integer of 0 to 20; n is an integer of 1 to 320; and the sum of m and p is 3.

10. The method as set forth in claim 9, wherein the optical material contains one or more substances selected from the group consisting of silicon, germanium, sapphire, calcium fluoride, barium fluoride, zinc selenide, and diamond.

11. The method as set forth in claim 9, wherein the solvent contains one or more substances selected from the group consisting of alcohols, ketones, ethers, aldehydes, amines, fatty acids, esters, and nitriles, and the solvent is modified with fluorine.

12. The method as set forth in claim 9, wherein the specimen is crushed using a needle having an end diameter of 2 to 10 μm.

13. The method as set forth in claim 9, wherein the modified surface of the optical material has a region with an area of 0.001 to 10 mm² enclosed by straight or curved lines with a width of 1 to 1,000 μm to retain a solution therein.

14. The method as set forth in claim 13, wherein the lines around the region have a raised part with a height of 0.001 to 1 μm.

15. The method as set forth in claim 13, wherein the lines around the region have a depressed part with a depth of 0.001 to 1 μm.

16. The method as set forth in claim 9, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

17. The method as set forth in claim 10, wherein the solvent contains one or more substances selected from the group consisting of alcohols, ketones, ethers, aldehydes, amines, fatty acids, esters, and nitriles, and the solvent is modified with fluorine.

18. The method as set forth in claim 10, wherein the specimen is crushed using a needle having an end diameter of 2 to 10 μm.

19. The method as set forth in claim 11, wherein the specimen is crushed using a needle having an end diameter of 2 to 10 μm.

20. The method as set forth in claim 10, wherein the modified surface of the optical material has a region with an area of 0.001 to 10 mm² enclosed by straight or curved lines with a width of 1 to 1,000 μm to retain a solution therein.

21. The method as set forth in claim 11, wherein the modified surface of the optical material has a region with an area of 0.001 to 10 mm² enclosed by straight or curved lines with a width of 1 to 1,000 μm to retain a solution therein.

22. The method as set forth in claim 12, wherein the modified surface of the optical material has a region with an area of 0.001 to 10 mm² enclosed by straight or curved lines with a width of 1 to 1,000 μm to retain a solution therein.

23. The method as set forth in claim 10, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

24. The method as set forth in claim 11, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

25. The method as set forth in claim 12, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

26. The method as set forth in claim 13, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

27. The method as set forth in claim 14, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.

28. The method as set forth in claim 15, wherein the modified surface of the optical material has a groove with a width of 0.01 to 1 mm and a depth of 0.001 to 0.1 mm or has a depression with a diameter of 0.01 to 1 mm and a depth of 0.001 to 0.1 mm.
